(19) United States
(12) Patent Application Publication
(10) Pub. No.: US 2007/0267882 A1
(43) Pub. Date: Nov. 22, 2007

(54) Gripping device

(75) Inventors: Younosuke Takahara, Yokohama-shi (JP); Yoshiyuki Morita, Yokohama-Shi (JP)

Correspondence Address: BURR & BROWN, PO BOX 7068, SYRACUSE, NY, 13261-7068, US

(73) Assignee: Toyo Seikan Kaisha Ltd., Chiyoda-Ku (JP)

(21) Appl. No.: 11/438,509

(22) Filed: May 22, 2006

(51) Int. Cl. B25J 15/08

(52) U.S. Cl. 294/106

(57) ABSTRACT

A gripping device includes a pair of grippers having one ends supported to be rotatable so as to be opened in an opposing direction so that the grippers grip circular peripheral portions of articles having different diameters with substantially same positions of centers of circular peripheral portions being maintained. Each of the grippers is provided with two projections at portions gripping the article, with a predetermined distance from each other, so that the projections of the grippers grip the article at four circular peripheral portions thereof.

### BACKGROUND OF THE INVENTION

1. Field of The Invention

The present invention relates to a gripping device for gripping a circular outer peripheral portion of an article by a pair of grippers which are hinged at one ends to be rotatable so as to be particularly capable of gripping the circular outer peripheral portions of the articles having different diameters without changing center positions of the outer peripheral portions of the articles to be gripped.

2. Related Art

Many kinds of gripping devices or apparatus for conveying containers, vessels or like by gripping a circular neck portion of the container or vessel such as pet bottle. When it is required to convey containers having different diameters, it is necessary to exchange the gripping device at each time. However, in a container conveying line, a number of, several hundreds, for example, gripping devices are used, and accordingly, such exchanging working involves much labor and cost. In order to reduce such labor and cost, there has been provided a gripping device capable of gripping the circular portions, having different diameters, of the articles, which is for example, disclosed in Japanese Patent Unexamined Application (KOKAI) Publication No. HEI 1-267214 (Publication 1).

The gripping device disclosed in this Publication 1 is provided with a pair of grippers which are rotatable symmetrically in opposing directions around rotation shafts to thereby grip the circular articles having different diameters. The grippers have V-shaped gripping, i.e. clamping, surfaces between which the circular articles are gripped so that when the circular articles having different diameters are gripped, the centers of the circular articles are positioned on an intersection point of bisector of the V-shaped grasping surfaces.

However, in the gripping device disclosed in the Publication 1, since the clamping surfaces of the grippers are formed to provide the V-shape, clamping surface is moved (changed) at its abutting point between the large diameter article and a small diameter article, and because of this reason, it is necessary to exactly form an inclination angle of the V-shaped clamping (gripping) surface and the inclination surface of the gripper.

Moreover, when a large diameter article is gripped, a distance between abutting portions to the V-shaped clamping surfaces is large, and when a small diameter article is gripped, such distance becomes narrow. In such, the gripped small diameter article is not stably held and is likely swung.

Japanese Utility Model Unexamined Application (KOKAI) Publication No. SHO 61-120493 and Japanese Patent Unexamined Application (KOKAI) Publication No. HEI 10-250838 also disclose gripping devices provided with grippers having V-shaped linear gripping or clamping surfaces, thus providing substantially the same problem as that proposed by the technology of the Publication 1 mentioned above.

### SUMMARY OF THE INVENTION

The present invention was conceived to solve the defects or drawbacks encountered in the prior art mentioned above and an object of the present invention is to provide a gripping device capable of surely and stably gripping articles having different circular diameter portions.

In order to achieve the above object, the present invention provides, in a preferred aspect, a gripping device including a pair of grippers having one ends supported to be rotatable so as to be opened in an opposing direction so that the grippers grip circular peripheral portions of articles having different diameters with substantially same positions of centers of circular peripheral portions of the articles being maintained, wherein each of the grippers is provided with two projections, with a predetermined distance from each other, so that the projections of the grippers grip the article at four circular peripheral portions thereof.

According to this aspect, an article is gripped at two portions of each gripper and four portions of the paired grippers, so that it is not necessary to precisely form an inclined V-shaped clamping surface as in a conventional structure.

Furthermore, since the distance between the two projections abutting the article does not change even if the articles having different outer peripheral diameters are gripped, the articles can be stably gripped without reducing the abutting distance as in the conventional structure when a small diameter article is gripped.

In the above aspect, in a preferred embodiment, it is desirable that the projections have end portions having a round shape, i.e. circular-arc shape in a side view. The projections may include at least one projection having an end portion having a radius of curvature of zero so as to provide a sharp front end to thereby provide rotation prevention function.

According to this embodiment, since the abutting front end of the projection is formed to be round in section in a side view, substantially the same abutting conditions can be always realized in spite of the articles having different diameters. In the case that at least one of the projections has a sharp front end, the article can be gripped without being rotated, so that the article can be more stably held.

Furthermore, it is also desirable that two projections formed to each of the grippers are positioned such that portions having different diameters are gripped with center positions of the circular peripheral portions to be gripped being substantially the same positions and moving angles with respect to rotation centers of the grippers are substantially equal to each other.

According to this embodiment, the positions of the projections can be easily and surely selected.

The nature and further characteristic features of the present invention will be made more clear from the following descriptions made with reference to the accompanying drawings.

### BRIEF DESCRIPTION OF THE DRAWINGS

In the accompanying drawings:

FIG. 1 shows a gripping device according to an embodiment of the present invention and includes FIGS. 1A to 1D, in which FIG. 1A is a schematic plan view showing a state that a bottle neck portion having a small diameter is gripped, FIG. 1B is also a schematic plan view showing a state that a bottle neck portion having a large diameter is gripped, FIG. 1C is a partial side view showing a state that the bottle neck portion is gripped, and FIG. 1D is an illustration showing a tip end of an sharp-angled projection of the gripping device;

FIG. 2A is a diagram representing a state of movement of a first projection of the gripping device at a time when the small bottle neck portion and the large bottle neck portion are gripped, and FIG. 2B is a diagram representing a state of movement of a second projection of the gripping device at a time when the small bottle neck portion and the large bottle neck portion are gripped; and

FIG. 3 is more detailed view of FIG. 2, in which FIG. 3A is a diagram showing the movement of the first projection and FIG. 3B is a diagram showing the movement of the second projection.

### DESCRIPTION OF THE PREFERRED EMBODIMENT

A preferred embodiment of the present invention will be described hereunder with reference to the accompanying drawings.

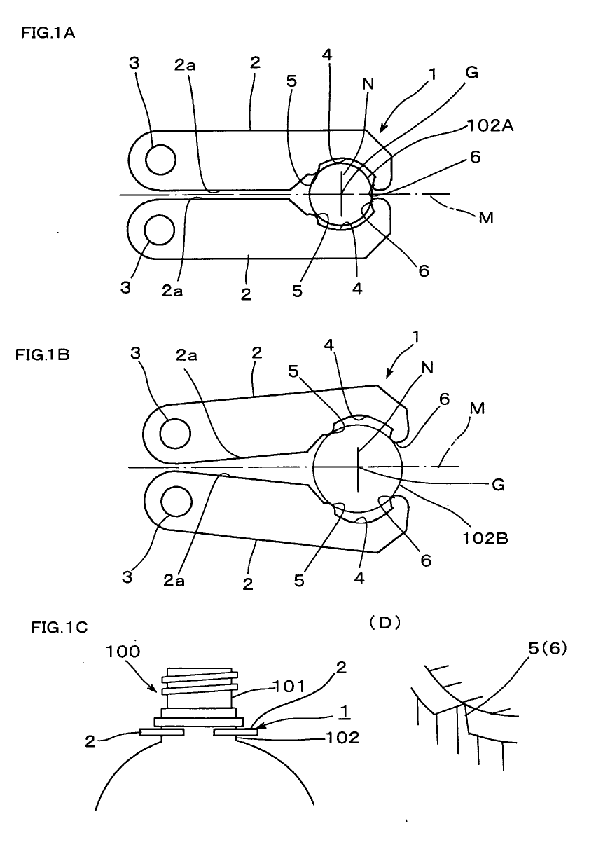

With reference to FIG. 1, showing a gripping or gripper device 1 according to the present invention, the gripping device 1 is utilized, as a neck gripper, gripping a bottle neck portion 102 of a pet bottle 100, for example. The bottle neck portion has a circular outer peripheral portion, and the gripping device grips, generally, a root portion of a mouth portion 101 of the pet bottle 100, as shown in FIG. 1C.

The gripping device 1 has a pair of grippers 2, 2 which are supported at their one ends to be rotatable around rotation shafts or pins 3, 3 so that other ends thereof are opened or closed symmetrically in opposing open/close direction as shown. The bottle neck portion 102 can be gripped by these paired grippers 2, 2. The grippers 2, 2 grip a first bottle neck portion 102A and a second bottle neck portion 102B having a diameter larger than that of the first bottle neck portion 102A with substantially the same central positions of the circular peripheral portions of the bottles to be gripped, which will be referred to as the gripping center G herein.

The grippers 2, 2 are plate-like members extending linearly and disposed symmetrically with respect to a symmetric axis line M passing the gripping center G. The rotation shafts 3, 3 of the respective grippers 2, 2 are positioned apart from the gripping center G by a distance corresponding to 2 to 3 times of the diameter of the neck portion 102A or 102B and separated from the symmetric axis line M by a distance slightly larger than a half of a width of the gripper 2. These grippers 2, 2 have facing surfaces 2a, 2a with slight gap such that when the first bottle neck portion 102A is gripped, the inner surfaces 2a, 2a of the grippers 2, 2 maintain their parallel relation as shown in FIG. 1A, and when the second bottle neck portion 102B is gripped, the inner surfaces 2a, 2a of the grippers 2, 2 have a predetermined angle opened symmetrically as shown in FIG. 1B.

Circular curved portions 4, 4 are formed on free end sides of the inner surfaces 2a, 2a of the grippers 2, 2 so as to surround the outer periphery of the bottle neck portion 102A (102B) with the gripping center G being the center thereof. First and second projections or protruded portions 5 and 6 are formed to the insides of the circular curved portions 4, 4 at portions apart from each other in the circumferential direction of the bottle neck portion 102A (102B) with a predetermined distance so that the bottle neck portion can be gripped by these projections 5 and 6 at four points. The projections 5 and 6 of each gripper 2 are positioned on both sides of a line N passing the gripping center G and perpendicularly to the axis line M. In the illustrated arrangement, the first projection 5 is positioned on the root side (rotation shaft side) of the curved portion 4 of the gripper 2 and the second projection is positioned on the tip end side thereof.

As shown in FIG. 1A, in the state of gripping the small diameter bottle neck portion (first bottle neck portion) 102A, the second projection 6 is positioned near the axis line M than the projection 5. On the other hand, as shown in FIG. 1B, in the state of gripping the large diameter bottle neck portion (second bottle neck portion) 102B, the projections 5 and 6 are both apart from the axis line M in comparison with the state of FIG. 1A. However, since the second projections 6 are largely apart from the axis line M in comparison with the first projections 5 because the second projections 6 are apart largely from the rotation shaft 3 in comparison with the first projections 5, and the distance between the second projection and the axis line M is almost equal to that between the first projection and the axis line M as shown in FIG. 1B.

The abutting portions of the first projections 5 and the second projections 6 against the first and second bottle neck portions 102A and 102B have round-shape, i.e. circular-arc shapes in a side view (longitudinal sectional view), respectively, and accordingly, in the state of gripping the small diameter first bottle neck portion 102A and the large diameter bottle neck portion 102B, contact points move along the circumferential direction of the bottle neck portion, so that the point contact state is maintained in both cases.

Further, at least one of these four projections, including two first projections 5 and two second projections 6, may be formed so as to have a sharp end shape having substantially no radius of curvature to thereby provide rotation prevention function in the article gripping state as shown in FIG. 1D.

As mentioned hereinabove, according to the gripping device 1 of the present invention, since the distance between the first and second projections 5 and 6 of each of the grippers 2, 2 does not vary even if the bottle neck portions having different diameters are gripped, so that the bottle can be stably gripped in spite of the case that the small bottle neck portion or large bottle neck portion is gripped.

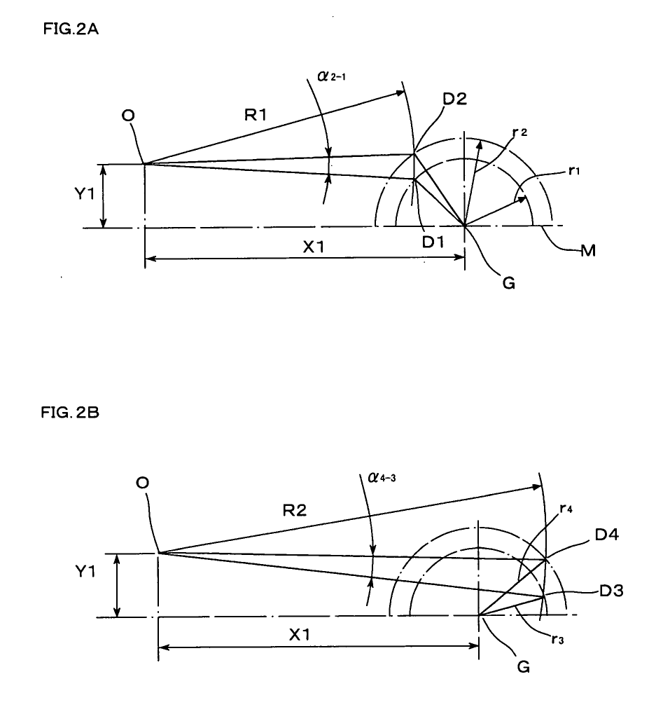

Hereunder, a method of deciding the size or dimension of the grippers will be described with reference to FIG. 2.

With reference to FIG. 2A, herein, distances from the gripping center G to the centers of the circular-arc portions of the first projections 5 abutting against the first and second bottle neck portions 102A and 102B are supposed to be r₁ and r₂, a distance from the rotation center O of the rotation shaft 3 of each gripper 2 to the center of the circular-arc portion of the first projection 5 is supposed to be R1, points of intersection between a circle described with the radius R1 and circles described with radii r₁ and r₂ are supposed to be D1 and D2, and an angle constituted by a line connecting the intersection point D1 and the rotation center O and a line connecting the intersection point D2 and the rotation center O is supposed to be α₂₋₁.

On the other hand, with reference to FIG. 2B, herein, distances from the gripping center G to the centers of the circular-arc portions of the second projections 6 abutting against the first and second bottle neck portions 102A and 102B are supposed to be r₃ and r₄, a distance from the rotation center O of the rotation shaft 3 of each gripper 2 to the center of the circular-arc portion of the second projection 6 is supposed to be R2, points of intersection between a circle described with the radius R2 and circles described with radii r₃ and r₄ are supposed to be D3 and D4, and an angle constituted by a line connecting the intersection point D3 and the rotation center O and a line connecting the intersection point D4 and the rotation center O is supposed to be α₄₋₃. The radii R1 and R2 are set so that the angles α₂₋₁ and α₄₋₃ become equal to each other.

In the above suppositions, these angles α₂₋₁ and α₄₋₃ correspond to the moving angles of the first and second projections 5 and 6 at the time of gripping the bottle nick portions 102A and 102B having different diameters.

That is, the positions of the first and second projections 5 and 6 are decided such that the moving angles α₂₋₁ and α₄₋₃ with respect to the rotation center O of the gripper 2 become equal to each other in a state in which the gripping centers G of the bottle neck portions 102A and 102B are substantially the same condition at the time of gripping the bottle neck portions 102A and 102B having different diameters.

The radii r₁ and r₂ are the sums of the neck diameters of the first and second bottle neck portions 102A and 102B and the radii of circular-arc portions of the first and second projections 5 and 6, respectively. Further, the radii r₃ and r₄ are also the sums of the neck diameters of the first and second bottle neck portions 102A and 102b and the radius of circular-arc portion of the second projection 6, respectively.

According to such settings of the moving angles and the radii, the central coordinate position X1 of the bottle neck portions 102A and 102B is positioned on the gripping center G without varying, and hence, a bottle (article) can be gripped at the first and second bottle neck portions 102A and 102B, even having different diameters, by the same gripping device 1.

In FIG. 2, the symmetric axis line M corresponds to the X-axis and an axis line passing the rotation center O and being perpendicular to the symmetric axis line M corresponds to the Y-axis. The center coordinate (X, Y) of the bottle neck portion 102A is made as (X1, 0) and the coordinate of rotation center) is made as (0, Y1).

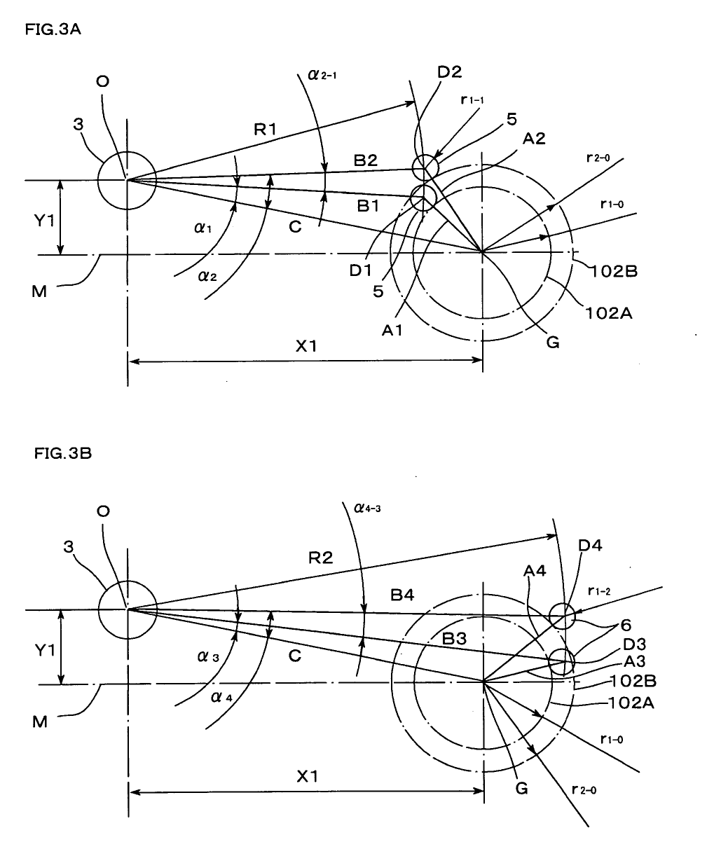

Next, with reference to FIG. 3, the above relationships will be explained in more detail, in which respective sides A1, A2, A3, A4, B1, B2, B3, B4 and C are represented by the following equations.
A1=r₁₋₀+r₁₋₁, A2=r₂₋₀+r₁₋₁, A3=r₁₋₀+r₁₋₂,
A4=r₂₋₀+r₁₋₂, B1=B2=R1, B3=B4=R2,
C=(X1²+Y1²)^{1/2}

The above equations will be explained as follows.

In FIG. 3, different from FIG. 2, the circular-arc radii of the first and second projections 5 and 6 are expressed as (r₁₋₁) and (r₁₋₂), and the radii of the first and second bottle neck portions 102A and 102B are expressed as (r₁₋₀) and (r₂₋₀).

The radius r₁ in FIG. 2A corresponds to the length (r₁₋₀+r₁₋₁) of the side A1 in FIG. 3A (line connecting the gripping center G and the circular-arc center D1 of the first projection 5 abutting against the first bottle neck portion 102A), and the radius r₂ in FIG. 2A corresponds to the length (r₂₋₀+r₁₋₁) of the side A2 in FIG. 3A (line connecting the gripping center G and the circular-arc center D2 of the first projection 5 abutting against the second bottle neck portion 102B). The radius r₃ in FIG. 2B also corresponds to the length (r₁₋₀+r₁₋₂) of the side A3 in FIG. 3B (line connecting the gripping center G and the circular-arc center D3 of the second projection 6 abutting against the first bottle neck portion 102A), and the radius r₄ in FIG. 2B corresponds to the length (r₂₋₀+r₁₋₂) of the side A4 in FIG. 3B (line connecting the gripping center G and the circular-arc center D4 of the second projection 6 abutting against the second bottle neck portion 102B).

Furthermore, the length of the side B1 in FIG. 3A (line connecting the rotation center O and the circular-arc center D1 of the first projection 5 abutting against the first bottle neck portion 102A) and the length of the side B2 in FIG. 3A (line connecting the rotation center O and the circular-arc center D2 of the first projection 5 abutting against the second bottle neck portion 102B) are both equal to the radius R1 in FIG. 2A. Furthermore, the length of the side B3 in FIG. 3B (line connecting the rotation center O and the circular-arc center D3 of the second projection 6 abutting against the first bottle neck portion 102A), and the length of the side B4 in FIG. 3B (line connecting the rotation center O and the circular-arc center D4 of the second projection 6 abutting against the second bottle neck portion 102B) are both equal to the radius R2 in FIG. 2B.

Opposite angles (diagonal angles) a of the respective sides A1, A2, A3 and A4 are shown as follows.
α₁=cos⁻¹(B1²+C²−A1²)/(2B1·C)
α₂=cos⁻¹(B2²+C²−A2²)/(2B2·C)
α₃=cos⁻¹(B3²+C²−A3²)/(2B3·C)
α₄=cos⁻¹(B4²+C²−A4²)/(2B4·C)

Large diameter and small diameter gripping moving angles are as follows.
α₂₋₁=α₂−α₁
α₄₋₃=α₄−α₃

Further, in order to provide a common gripping device for the first bottle neck portion having small diameter and the second bottle neck portion having large diameter, it is necessary to set the values of X1, Y1, R1, R2, r₁₋₁, r₁₋₂, respectively, so as to provide α₂₋₁=α₄₋₃.

In the case where the circular-arc radii r₁₋₁ and r₁₋₂ of the first and second projections 5 and 6 of the gripping device are made zero, the gripping device serves as one provided with bottle rotation preventing function.

The following Table 1 represents an example of concrete calculation, which was performed with the following parameters of values: X1=−70.5; Y1=14; R1=60; R2=85.6; r₁₋₂=r₁₋₁=2.5; r₁₋₀=13; and r₂₋₀=17.5.

TABLE 1

| Neck Diameter (mm) | X1 Coordinate | Shifting (mm) |
|---|---|---|
| 24 | 70.625 | −0.125 |
| 25 | 70.552 | −0.052 |
| 26 | 70.5 | Reference |
| 27 | 70.463 | 0.037 |
| 28 | 70.439 | 0.061 |
| 29 | 70.425 | 0.075 |
| 30 | 70.419 | 0.081 |
| 31 | 70.422 | 0.078 |
| 32 | 70.432 | 0.068 |
| 33 | 70.449 | 0.051 |
| 34 | 70.471 | 0.029 |
| 35 | 70.5 | 0 |
| 36 | 70.534 | −0.034 |
| 37 | 70.574 | −0.074 |

As shown in the Table 1, in the case of the diameters of the bottle neck portions of 26 mm and 35 mm, the coordinate X1 of the center of the bottle neck portion accords with the gripping center G, and the shifting at that time is 0.081 mm in maximum, which is a value considered to be ignored in practice.

It is further to be noted that the present invention is not limited to the described embodiment and many other changes and modifications may be made without departing from the scopes of the appended claims.

What is claimed is:

1. A gripping device including a pair of grippers having one ends supported to be rotatable so as to be opened in an opposing direction so that the grippers grip circular peripheral portions of articles having different diameters with substantially same positions of centers of circular peripheral portions of the articles being maintained, wherein each of the grippers is provided with two projections, with a predetermined distance from each other, so that the projections of the grippers grip the articles at four circular peripheral portions thereof.

2. The gripping device according to claim 1, wherein the projections have end portions having a circular-arc shape in a side view.

3. The gripping device according to claim 2, wherein the projections includes at least one projection having an end portion having a radius of curvature of zero so as to provide a sharp front end to thereby provide rotation prevention function.

4. The gripping device according to claim 1, wherein two projections formed to each of the grippers are positioned such that portions having different diameters are gripped with center positions of the circular peripheral portions to be gripped being substantially the same positions and moving angles with respect to rotation centers of the grippers are substantially equal to each other.
